(19) United States
(12) Patent Application Publication
(10) Pub. No.: US 2026/0120234 A1
(43) Pub. Date: Apr. 30, 2026

(54) IMAGE PROCESSING DEVICE, IMAGE PROCESSOR AND IMAGE PROCESSING METHOD

(71) Applicant: Realtek Semiconductor Corporation, Hsinchu (TW)

(72) Inventors: Chi Jen ZHANG, Hsinchu (TW); Wan Jou LEE, Hsinchu (TW); Sheng Ju YANG, Hsinchu (TW); Cheng Yueh CHEN, Hsinchu (TW); Wen-Hsia KUNG, Hsinchu (TW)

(21) Appl. No.: 19/347,761

(22) Filed: Oct. 2, 2025

Related U.S. Application Data
(60) Provisional application No. 63/711,165, filed on Oct. 24, 2024.

(30) Foreign Application Priority Data
Jun. 6, 2025 (TW) 114121244

(51) Int. Cl. G06T 3/40; G06T 11/00

(52) U.S. Cl. CPC G06T 3/40; G06T 11/00

(57) ABSTRACT

An image processing method comprises: receiving an initial image by an image processor; setting a first core image and a first peripheral image according to a regional parameter and the initial image, wherein the region parameter is configured to indicate the size of the first core image; and adjusting the size of the first core image and the first peripheral image respectively to generate a second core image and a second peripheral image, wherein the adjustment ratios of the first core image and the first peripheral image are different.

### CROSS-REFERENCE TO RELATED APPLICATION

This application claims priority to U.S. Provisional Application Ser. No. 63/711,165 filed Oct. 24, 2024, and Taiwan Application Serial Number 114121244, filed Jun. 6, 2025, the disclosures of which are incorporated herein by reference in their entireties.

### BACKGROUND

### Technical Field

The present disclosure relates to image processing technology, and more particularly to an image processing device, an image processor and an image processing method.

### Description of Related Art

In electronic sports gaming, the “field of view (FOV)” displayed by a display panel directly impacts the reaction time, decision and operational precision of players. A larger field of view enables players to perceive more information in the electronic sports game, such as the status of the environment or opponents. However, a larger field of view also means that the displayed area for each object's features is smaller on the screen, making the discernment of details more challenging, such as an opponent's movements. In other words, the images presented by different field of view sizes have their own advantages and disadvantages for the electronic sports game, but it is difficult to take into account the different needs of players.

### SUMMARY

One aspect of the present disclosure is an image processing method, comprising: receiving, by an image processor, an initial image; setting a first core image and a first peripheral image according to a regional parameter and the initial image, wherein the region parameter is configured to indicate the size of the first core image; and adjusting the sizes of the first core image and the first peripheral image respectively to generate a second core image and a second peripheral image, wherein an adjustment ratio of the first core image and an adjustment ratio the first peripheral image are different.

Another aspect of the present disclosure is an image processing device, comprising a display panel and an image processor. The image processor is electrically connected to the display panel, and is configured to receive an initial image. The image processor is further configured for: setting a first core image and a first peripheral image according to a regional parameter and the initial image, wherein the region parameter is configured to indicate the size of the first core image; and adjusting the sizes of the first core image and the first peripheral image respectively to generate a second core image and a second peripheral image, wherein an adjustment ratio of the first core image and an adjustment ratio the first peripheral image are different.

Another aspect of the present disclosure is an image processor configured to receive an initial image. The image processor is configured for: setting a first core image and a first peripheral image according to a regional parameter and the initial image, wherein the region parameter is configured to indicate the size of the first core image; and adjusting the sizes of the first core image and the first peripheral image respectively to generate a second core image and a second peripheral image, wherein an adjustment ratio of the first core image and an adjustment ratio the first peripheral image are different.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1A is a schematic diagram of a display system in some embodiments of the present disclosure.

FIG. 1B is a schematic diagram of a display system in some embodiments of the present disclosure.

FIG. 2 is a flowchart illustrating an image processing method in some embodiments of the present disclosure.

FIG. 3 is a schematic diagram of the screen displayed by the image processing device in some embodiments of the present disclosure.

FIG. 4A is a schematic diagram of the screen displayed by the image processing device in some embodiments of the present disclosure.

FIG. 4B is a schematic diagram of the sampling method of the image processing device in some embodiments of the present disclosure.

FIGS. 4C-4E are schematic diagrams of screens displayed by the image processing device in different processing methods.

FIG. 5 is a flowchart illustrating an image processing method in some embodiments of the present disclosure.

FIG. 6 is a schematic diagram of the screen displayed by the image processing device in some embodiments of the present disclosure.

FIGS. 7A-7C are schematic diagrams of screens displayed by the image processing device in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes associated listed items or any and all combinations of more.

The present disclosure relates to image scaling technology, which can be implemented by an image processing device (e.g., an image processor in a display device) or implemented as an image processing method within a processor. In the subsequent embodiments, “game screen” is used as an example to illustrate the features and operation of the present disclosure. However, the present disclosure is not limited thereto, in other embodiments, the present disclosure can also be used for displaying video streams or static images.

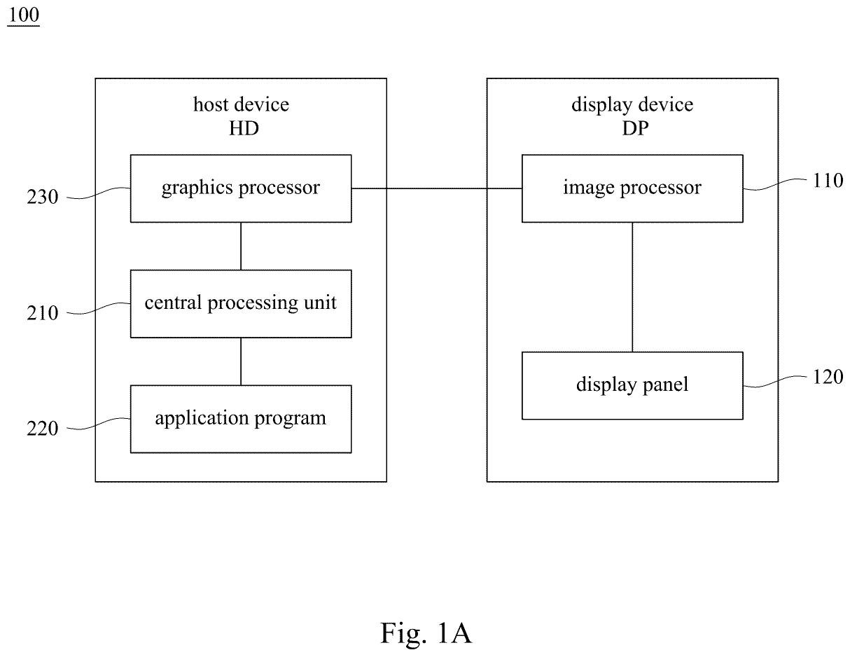

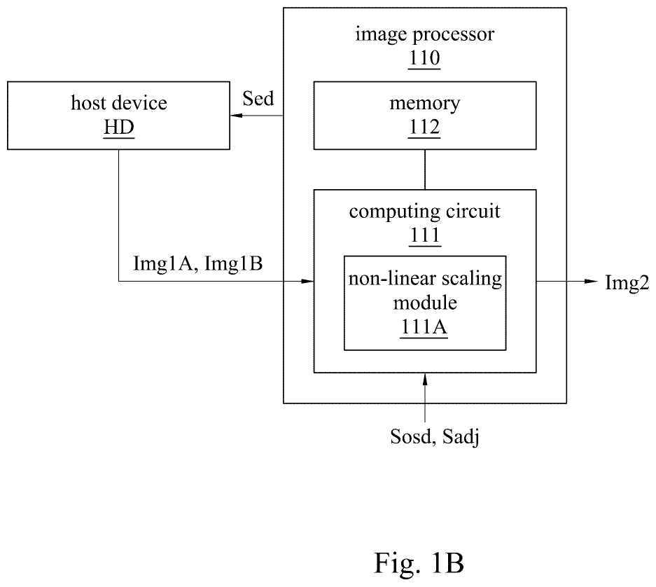

The application circuit of the present disclosure is described below: FIG. 1A is a schematic diagram of a display system 100 in some embodiments of the present disclosure. The display system 100 includes a host device HD and a display panel DP. In one embodiment, the display panel DP is coupled to the host device HD to receive an image data from a graphics processor (Graphics Processing Unit, GPU) 230 in the host device HD. The display panel DP includes an image processor 110 (e.g., a scaler) and a display panel 120. The image processor 110 is configured to analyze the image data and drive the display panel 120 according to the image data to display the corresponding image screen.

In some embodiments, the host device HD can be a host computer, and the display device DP can be a computer monitor, which is coupled to the host device HD via wired or wireless communication, but the present disclosure is not limited thereto.

In some embodiments, the host device HD further includes a central processing unit 210, and the central processing unit 210 is installed an application program 220 (e.g., a program file stored in a memory). The application program 220 can be an electronic game, a streaming program, or an audio/video display program. When the central processing unit 210 executes the application program 220, the central processing unit 210 generates the corresponding image data by the graphics processor 230, and transmits the image data to the display device DP to display an image corresponding to the application program 220, such as a game screen.

FIG. 1B is a schematic diagram of certain features of the display system 100 in some embodiments of the present disclosure. Referring to FIGS. 1A and 1B, the image processor 110 includes a computing circuit 111 and a memory 112. The computing circuit 111 is electrically connected to the memory 112. The memory 112 is configured to store cache data used when the image processor 110 operates, and to store device information of the display device DP (e.g., the model, size ratio, and resolution of the display panel 120). Specifically, when the host device HD executes the application program 220, the host device HD transmits an initial image Img1A to the image processor 110. The image processor 110 generates an output image Img2 according to the initial image Img1A. Detail content in FIG. 1B (e.g., the adjusted image Img1B, the non-linear scaling module 111A) will be detailed in subsequent paragraphs.

The “initial image/output image” refers to image signals or image data (e.g., pixel value) that record a specific screen, and may correspond to a single static image or multiple dynamic images. The output image includes a corresponding driving signal for a specific image screen, such as a driving voltage generated according to a pixel value. Since one of ordinary skill in the art can understand the meaning of image signals such as “initial image/output image,” it will not be described herein.

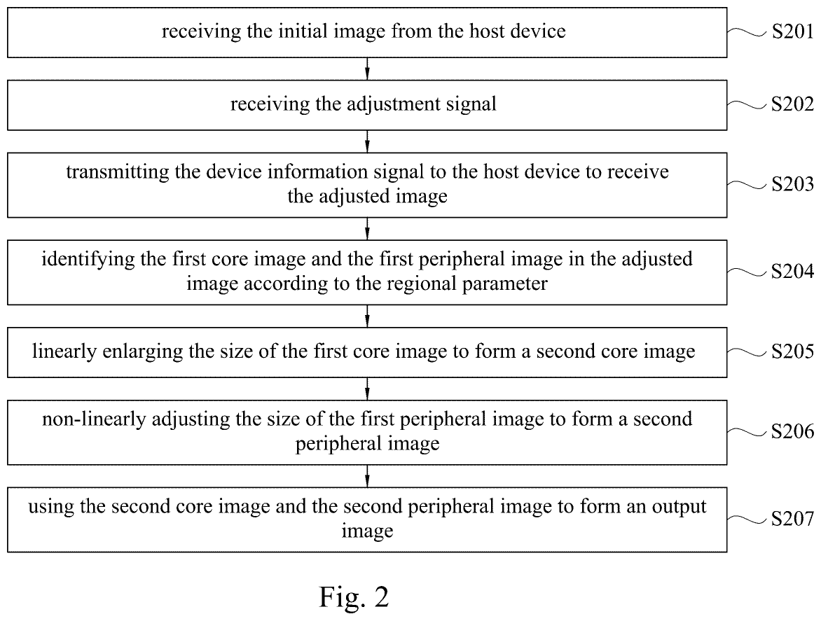

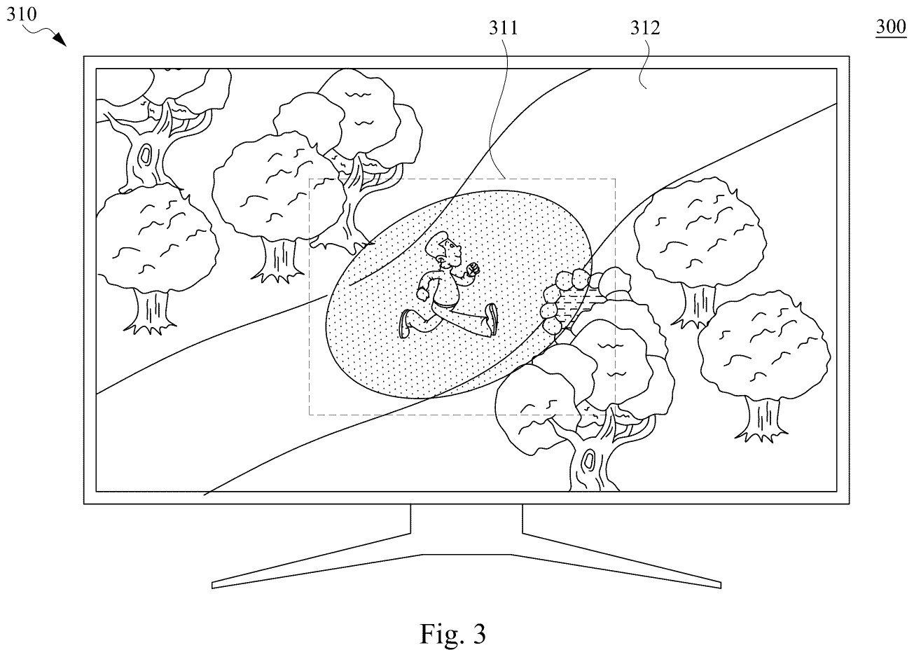

The following uses FIGS. 1A-3 as an example to illustrate an implementation of the present disclosure. FIG. 2 is a flowchart illustrating an image processing method in some embodiments of the present disclosure. FIG. 3 is a schematic diagram of the screen displayed by the image processing device in some embodiments of the present disclosure, wherein the display device 300 can be implemented as the display device DP in FIG. 1A. In this embodiment, the image processing device is implemented by the display device DP, but the present disclosure is not limited thereto. In other embodiments, the image processor 110 can be arranged outside the display device DP, and communicatively coupled to the display panel 120 via wired or wireless communication. Furthermore, operations performed by the image processor 110 (the computing circuit 111) described below can also be performed by the central processing unit 210 or the computing circuit of the graphics processor 230.

In step S201, the image processor 110 receives the initial image Img1A from the graphics processor 230 of the host device HD. The “initial screen 310” shown in FIG. 3 is the screen displayed/presented by the display panel 120 when the display device 300 does not adjust the content of the initial image Img1A (i.e., the image processor 110 does not adjust the display manner of the initial image Img1A). Under normal operating conditions, if the user does not input an adjustment signal Sadj to activate an “expansion function,” the image processor 110 will directly drive the display panel 120 according to the initial image Img1A.

If the field of view of the game is to be changed, one way is to use the “adjust ratio” function in the application program 220 to adjust the display ratio of the initial image Img1A. However, since the size of the display panel 120 is fixed, the display panel 120 is not ideal for displaying images of other ratios. For example, if the aspect ratio of the display panel 120 is “4:3,” and the display ratio of the initial image Img1A is manually adjusted from the preset “4:3” to “16:9,” then due to the mismatch in aspect ratio, there will have black bars at the top and bottom of the screen. In other words, the display area of the display panel 120 used for displaying the game screen will become smaller, which is more inconvenient for viewing.

On the other hand, if the image processor 110 forces the “16:9” image to fill the display area (i.e., a “4:3” ratio) of the display panel 120, the contours of objects on the screen will be distorted (e.g., an originally perfect circle becomes an ellipse). For electronic sports games, object distortion will affect the judgment and operational precision of user. The present disclosure, through subsequent steps S202-S207, adjusts the image size in different ways for different partial regions of the initial image Img1A/the initial screen 310, so as to take into account both the “field of view” and the “accuracy of objects in the image.”

In step S202, when the user inputs the adjustment signal Sadj to the display device DP/300 by an input device (e.g., a mouse, keyboard, or on-screen buttons), the image processor 110 activates the “expansion function” according to the received adjustment signal Sadj.

The purpose of the “expansion function” is to increase the field of view, and thus the display ratio of the image must be changed. In this embodiment, the display panel 120 is described as having a size ratio of 4:3. In other words, the aspect ratio of the initial image Img1A/the initial screen 310 is also “4:3.”

In step S203, the image processor 110 transmits a device information signal Sed in the memory 112 to the host device HD. The device information signal Sed can be a display tag parameter (e.g., Extended Display Identification Data, EDID), including a first aspect ratio (e.g., 16:9). This first aspect ratio is different from a second aspect ratio of the display panel 120 (e.g., the size ratio “4:3” of the display panel 120), and the resolution corresponding to the first aspect ratio is greater than the resolution corresponding to the second aspect ratio, so it is able to display a larger field of view. After receiving the device information signal Sed, the graphics processor 230 in the host device HD changes the size of the initial image Img1A according to the device information signal Sed, so as to generate/provide the adjusted image Img1B, which has the first aspect ratio.

Although the adjusted image Img1B with the first aspect ratio has a larger field of view, it is mismatch the size ratio of the display panel 120. Therefore, directly displaying the adjusted image Img1B would lead to the aforementioned “black bar” problem. Accordingly, the present disclosure modifies/adjusts the image of the adjusted image Img1B in different ways to avoid the issues of “black bars” or “object distortion.”

Specifically, in step S204, the computing circuit 111 of the image processor 110 identifies a first core image 311 and a first peripheral image 312 in the adjusted image Img1B according to a regional parameter. As shown in FIG. 3, the first core image 311 includes a game character and a skill casting range of the game character, which is the area that the user focuses on.

The regional parameter is configured to indicate the size of the first core image 311, such as determining the radius of a circular region, or determining the length and width of a rectangular region. Therefore, the image processor 110 can identify a core region in the adjusted image Img1B according to the regional parameter, so as to set a portion of the adjusted image Img1B corresponding to the core region as the first core image 311, and set other portions of the adjusted image Img1B as the first peripheral image 312.

In one embodiment, the position of the first core image 311 is preset to be at the center of the screen. The length of the first core image 311 is fixed, so the regional parameter is only used to determine the width of the first core image 311, such as 600 pixels, or 30% of the total horizontal width.

In step S205, the image processor 110 is configured to linearly enlarge the size of the first core image 311 to form a second core image. “Enlarge linearly” means that the first core image 311 will be scaled proportionally, so the contours of objects will not be distorted. In other embodiments, the computing circuit 111 of the image processor 110 can also non-linearly enlarge the first core image 311 into the second core image according to a preset scaling parameter (e.g., length adjusted to 110%, width maintained at 100%). The aforementioned “regional parameter” and “scaling parameter” can be preset in the image processor, but can also be input or adjusted by the user, such as inputting an On-Screen Display (OSD) setting signal Sosd to the display device DP.

In step S206, the image processor 110 is further configured to non-linearly adjust/scale the size of the first peripheral image 312 to form a second peripheral image. The adjustment ratio of the first core image 311 is different from the adjustment ratio of the first peripheral image.

In step S207, the image processor 110 uses the second core image and the second peripheral image to form an output image Img2 conforming to the second aspect ratio, and drives the display panel 120 to generate the corresponding screen.

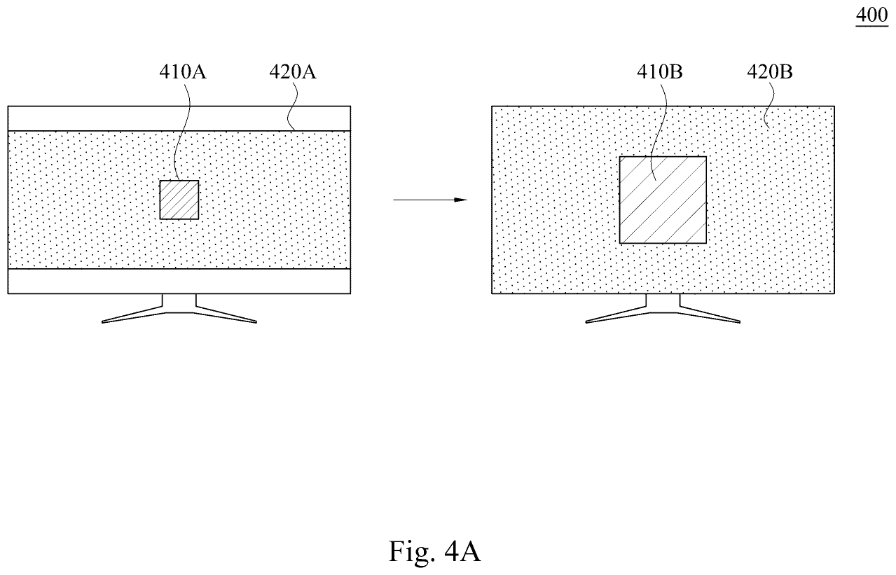

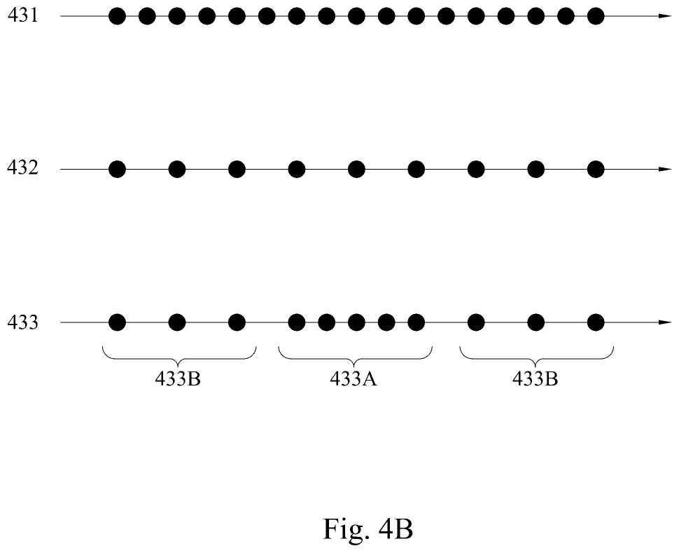

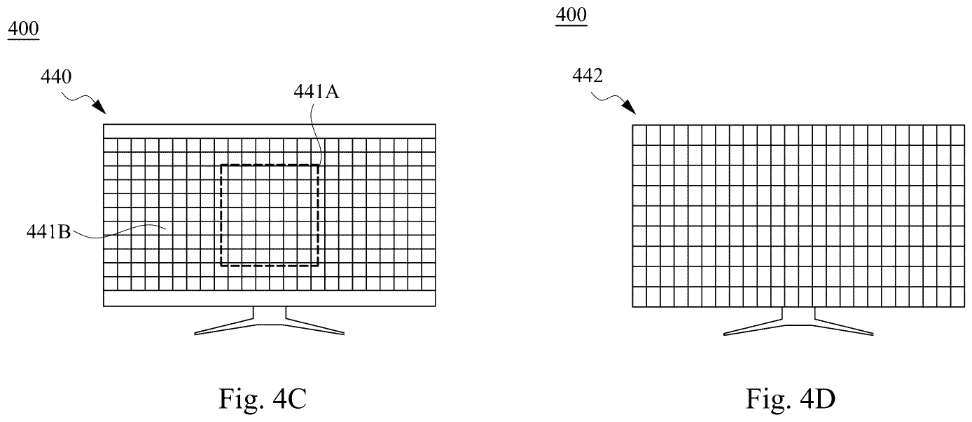

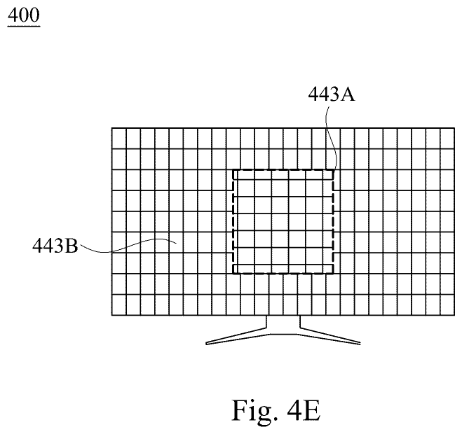

To facilitate understanding of how “the adjusted image Img1B” is adjusted to “the output image Img2,” referring to the schematic diagram of the screen shown in FIG. 4A, wherein the display device 400 can be implemented as the display device DP in FIG. 1A or the display device 300 in FIG. 3. In FIG. 4A, the first core image 410A and the first peripheral image 420A are respectively a portion of the adjusted image Img1B. At this time, because the first aspect ratio of the adjusted image Img1B does not match the second aspect ratio of the display panel, there will have “black bars” because the adjusted image Img1B can not directly fill the display area of the display panel.

As mentioned above, as the aforemention step S205, since the first core image 410A is linearly enlarged to the second core image 410B, it will occupy more area. Therefore, the size of the first peripheral image 420A will be adjusted according to “other display regions except the second core image 410B”, so that the second peripheral image 420B can fill the “other display regions except the second core image 410B.”

Accordingly, since the second core image 410B is enlarged linearly (or the degree of non-linear scaling is relatively small), objects will not be distorted, and the user can correctly identify objects in the screen. On the other hand, although objects in the second peripheral image 420B may have distortion, the second peripheral image 420B is not the core region in the screen. Therefore, the primary purpose of the second peripheral image 420B is to fill “other display regions except the second core image 410B” to enhance the field of view. By respectively adjusting the sizes of the first core image 410A and the first peripheral image 420A, the demands of “increasing the field of view” and “maintaining the accuracy of objects in the core region” can be balanced.

It is important to note that although in the aforementioned embodiments, the first core image 410A is “enlarged” to the second core image 410B, in other embodiments, the first core image may also be “reduced” to the second core image to modify the adjusted image into the output image.

Hereinafter, the image scaling of the present disclosure will be described with reference to FIGS. 1A-4B, wherein FIG. 4B shows a schematic diagram of a sampling method of the image processing device (e.g., the display device) according to some embodiments of the present disclosure. In some embodiments, the image processor 110 performs enlargement and/or reduction by a non-linear scaling module 111A. If it is “uniformly enlarging or reducing a single image,” the image will be sampled with a fixed scaling factor. For example, the sampling method 431 shown in FIG. 4B is configured to “uniformly enlarge,” which requires sampling multiple pixel values of the image. After sampling, the pixel values of the enlarged image can be obtained by interpolation.

The sampling method 432 shown in FIG. 4B is configured to “uniformly” reduce the image. Since the reduced image includes fewer pixels, the number of sampling frequencies is also lower. As mentioned above, “uniformly” enlarging/reducing has the problem of “mismatched aspect ratio,” and thus is not ideal.

The sampling method 433 shown in FIG. 4B corresponds to the aforementioned steps S201-S207, wherein the core region 433A (corresponding to the first core image) has a higher sampling frequency, and the peripheral regions 433B (corresponding to the first peripheral image) have a lower sampling frequency. Therefore, by using different methods to adjust the size for different regions, both the field of view and the object accuracy can be balanced.

To facilitate understanding, the screen displayed by the image processing device in different processing methods will be further explained below with reference to FIGS. 1A, 1B, and 4C-4E. FIG. 4C shows the image screen 440 displayed by the display device 400 after the graphics processor 230 converts the initial image Img1A to the adjusted image Img1B according to the first aspect ratio. As shown in FIG. 4C, since the first aspect ratio is different from the size ratio (the second aspect ratio) of the display device 400, the top and bottom of the image screen 440 will have “black bars”.

FIG. 4D shows an image screen 442 formed when the adjusted image Img1B is forced to adjust to match to the size ratio (the second aspect ratio) of the display device 400. As shown in FIG. 4D, due to the aspect ratio mismatch, the contour of objects in the image screen 442 will be distorted (e.g., the square in FIG. 4C is deformed into a rectangle in FIG. 4D), thus the display effect is not ideal. FIG. 4E shows the image screen generated according to the image processing method shown in FIG. 2. As described in the method shown in FIG. 2, the image processor first identifies the first core image 441A and the first peripheral image 441B from the adjusted image Img1B. Next, the image processor separately adjusts the sizes of the first core image 441A and the first peripheral image 441B to generate the second core image 443A and the second peripheral image 443B shown in FIG. 4E.

The first core image 441A and the first peripheral image 441B in FIG. 4C can be equivalent to the first core image 410A and the first peripheral image 420A shown in FIG. 4A. The second core image 443A and the second peripheral image 443B in FIG. 4E can be equivalent to the second core image 410B and the second peripheral image 420B shown in FIG. 4A. As shown in FIG. 4E, the second core image 443A is a linearly enlarged image and is not distorted, and the second peripheral image 443B can fill the entire display area without generating “black bars.”

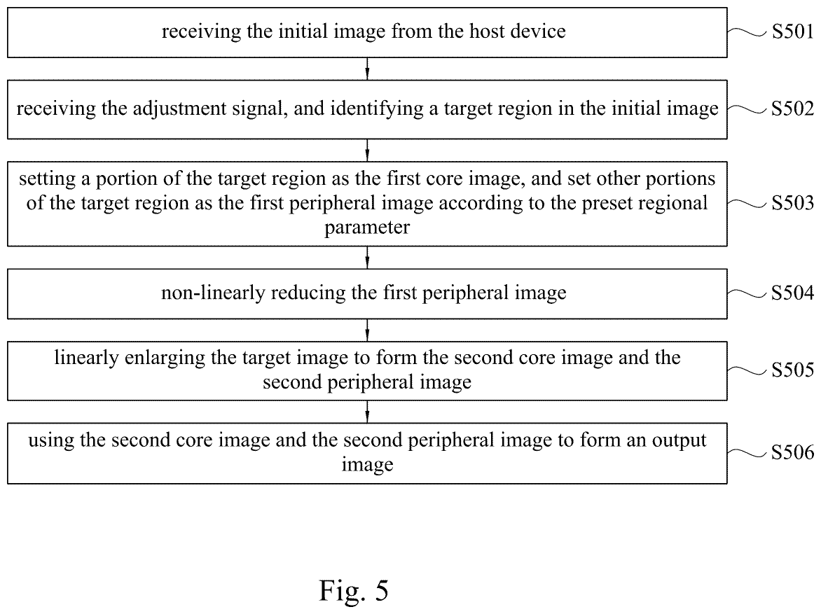

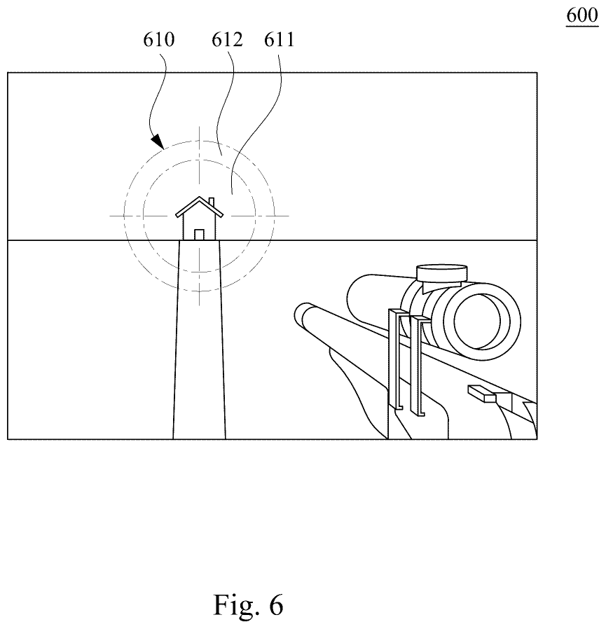

Hereinafter, the operation of another embodiment of the present disclosure will be described with reference to FIGS. 1A, 1B, 5, and 6. FIG. 5 shows a flowchart of an image processing method in some embodiments of the present disclosure. FIG. 6 shows a schematic diagram of a screen displayed by the image processing device (e.g., the display device DP) according to some embodiments of the present disclosure. In this embodiment, a “first-person shooter (FPS)” game is taken as an example for illustration.

As shown in FIG. 6, in the FPS game, user can enable “Sniper Scope” function to enlarge a partial region of the screen. However, in some technologies, after the “Sniper Scope” enlarges the partial image, it will cover (obscure) other surrounding images, affecting the viewing field of view (i.e., the blind spot of vision). The present disclosure can avoid covering surrounding images by changing the display size of different regions in different ways.

Please refer to FIGS. 1A, 1B, 5, and 6. In step S501, the image processor 110 receives the initial image Img1A from the host device HD, and drives the display panel 120 to display the initial screen 600 (as shown in FIG. 6) according to the initial image Img1A.

In step S502, when the user inputs an adjustment signal Sadj to the display device DP by an input device (e.g., selecting to enable the “Sniper Scope” function by a mouse, keyboard, or on-screen buttons), the image processor 110 will identify a target region in the initial image Img1A/the initial screen 600 according to the received adjustment signal Sadj. In one embodiment, the adjustment signal Sadj includes a coordinate position (e.g., the position pointed to by the weapon of the game), and the image processor 110 has a preset range of the target region 610 (i.e., the area that the “Sniper Scope” should display). The image processor 110 centers on the coordinate position indicated by the adjustment signal Sadj, and sets the target region in the initial image Img1A/the initial screen 600 according to the preset range.

In step S503, the image processor 110 will set a portion of the target region 610 as the first core image 611, and set other portions of the target region 610 as the first peripheral image 612 according to the preset regional parameter. In this embodiment, the regional parameter can be the proportion that the first core image 611 occupies within the target region 610.

It is important to note that the first core image 611 needs to be enlarged, but the enlarged image cannot cover other images. Therefore, the method by the present disclosure is similar to the aforementioned steps S204-S207, further dividing the target region 610 into two regions (i.e., the first core image 611 and the first peripheral image 612), and adjusting their sizes with different display ratios for different regions.

Specifically, in step S504, the image processor 110 will fix/maintain the first core image 611, and non-linearly reduce the first peripheral image 612. To facilitate illustration, the reduced first peripheral image 612 and the fixed/maintained first core image 611 are referred to as the “target image.” The reduction ratio of the first peripheral image 612 can be determined by the user or the application program (e.g., the magnification level of the Sniper Scope). In other embodiments, the image processor 110 can also linearly adjust/scale the size of the first core image 611 to form the target image.

Next, in step S505, the image processor 110 will linearly enlarge the target image to form the second core image and the second peripheral image. In other words, the enlarged target image includes the second peripheral image with non-linear processing and the second core image with linear processing. In this embodiment, the total area of the finally generated second core image and second peripheral image will be equal to the total area of the first core image 611 and the first peripheral image 612, which is the size of the target region 610. Therefore, the second core image and the second peripheral image will not cover (obscure) the images outside the target region. In other embodiments, the image processor 110 can also non-linearly reduce or enlarge the first core image 611, and is not limited to linear adjustment.

In step S506, the image processor 110 uses the second core image and the second peripheral image to form the output image. Specifically, the image processor 110 can maintain the display ratio of “other regions in except the target region 610” in the initial image Img1A/the initial screen 600, so as to used as a background image. Subsequently, the image processor 110 integrates the background image, the second core image, and the second peripheral image into the output image, and the size and aspect ratio of the integrated output image Img2 will remain the same as the initial image Img1A/the initial screen 600.

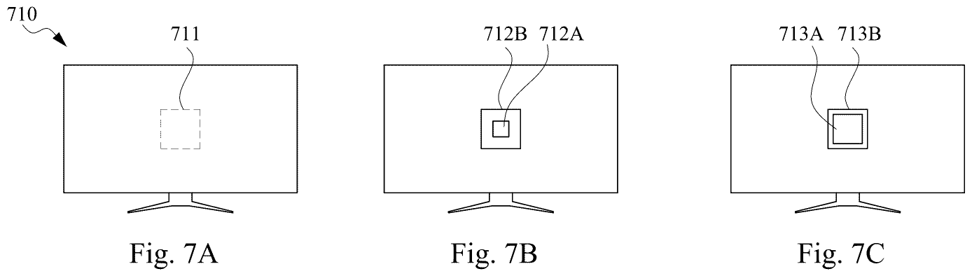

To facilitate understanding of how the “initial image Img1A” is adjusted to the “output image Img2,” the following uses a schematic diagram of the screen shown in FIGS. 7A-7C for illustration. The initial screen 710 shown in FIG. 7A can be equal to the initial screen 600 shown in FIG. 6, and the target region 711 can be the target region 610 in FIG. 6.

As shown in FIGS. 7A and 7B, the target region 711 is a preset display range of the “Sniper Scope” function. As the aforementioned step S504, the image processor 110 identifies the first core image 712A and the first peripheral image 712B in the target region 711.

As the aforementioned steps S504 and S505, the image processor 110 first non-linearly reduces the first peripheral image 712B, so that the first core image 712A and the reduced first peripheral image 712B to form the target image. Subsequently, the image processor 110 linearly enlarges the entire target image, thereby generating the second core image 713A and the second peripheral image 713B shown in FIG. 7C. As shown in FIG. 7C, the total area of the second core image 713A and the second peripheral image 713B will be equal to the area of the initial target region 711.

Accordingly, by first non-linearly reducing the first peripheral image 712B and then uniformly linearly enlarging the target image, the demands of both “partial enlargement” and “avoiding blind spots in the field of view” can be balanced. In other words, not only is the content of the first core image 712A enlarged, but the enlarged second core image 713A and second peripheral image 713B will not cover (obscure) other images outside the target region 711.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. An image processing method, comprising:
receiving, by an image processor, an initial image;
setting a first core image and a first peripheral image according to a regional parameter and the initial image, wherein the region parameter is configured to indicate the size of the first core image; and
adjusting the sizes of the first core image and the first peripheral image respectively to generate a second core image and a second peripheral image, wherein an adjustment ratio of the first core image and an adjustment ratio the first peripheral image are different.

2. The image processing method of claim 1, wherein adjusting the size of the first core image and the first peripheral image respectively comprises:
non-linearly adjusting the size of the first peripheral image to form the second peripheral image.

3. The image processing method of claim 2, wherein adjusting the size of the first core image and the first peripheral image respectively further comprises:
scaling the first core image linearly to form the second core image.

4. The image processing method of claim 1, further comprising:
transmitting a device information signal to a host device so that the host device changes the size of the initial image and provides an adjusted image, wherein the adjusted image has a first aspect ratio, and the first core image and the first peripheral image are respectively a portion of the adjusted image; and
using the second core image and the second peripheral image to form an output image conforming to a second aspect ratio, wherein the first aspect ratio and the second aspect ratio are different.

5. The image processing method of claim 4, further comprising:
identifying a core region in the adjusted image according to the regional parameter; and
setting a portion of the adjusted image corresponding to the core region as the first core image, and setting other portions of the adjusted image as the first peripheral image.

6. The image processing method of claim 1, further comprising:
identifying a target region in the initial image according to an adjustment signal; and
setting a portion of the target region as the first core image, and setting other portions of the target region as the first peripheral image according to the regional parameter.

7. The image processing method of claim 6, wherein adjusting the size of the first core image and the first peripheral image respectively comprises:
non-linearly reducing the first peripheral image to generate a target image, wherein the target image comprises the first core image and the reduced first peripheral image; and
linearly enlarging the target image to form the second core image and the second peripheral image.

8. The image processing method of claim 6, wherein identifying the target region in the initial image comprises:
centering on a coordinate position indicated by the adjustment signal, and setting the target region in the initial image according to a preset range.

9. The image processing method of claim 8, further comprises:
maintaining a display ratio of other regions in the initial image except the target region, as a background image; and
integrating the background image, the second core image and the second peripheral image into an output image, wherein the size of the output image is equal to the size of the initial image.

10. An image processing device, comprising:
a display panel; and
an image processor electrically connected to the display panel, and configured to receive an initial image, wherein the image processor is further configured for:
setting a first core image and a first peripheral image according to a regional parameter and the initial image, wherein the region parameter is configured to indicate the size of the first core image; and
adjusting the sizes of the first core image and the first peripheral image respectively to generate a second core image and a second peripheral image, wherein an adjustment ratio of the first core image and an adjustment ratio the first peripheral image are different.

11. The image processing device of claim 10, wherein the image processor is configured to non-linearly adjust the size of the first peripheral image to form the second peripheral image.

12. The image processing device of claim 10, wherein the image processor is configured to scale the first core image linearly to form the second core image.

13. The image processing device of claim 10, wherein the image processor is configured to transmit a device information signal to a host device so that the host device changes the size of the initial image and provides an adjusted image, wherein the adjusted image has a first aspect ratio; and
wherein the image processor is further configured to use the second core image and the second peripheral image to form an output image conforming to a second aspect ratio, wherein the first aspect ratio and the second aspect ratio are different, and the first core image and the first peripheral image are a portions of the adjusted image.

14. The image processing device of claim 13, wherein the image processor is configured to identify a core region in the adjusted image according to the regional parameter; and
wherein the image processor is further configured to set a portion of the adjusted image corresponding to the core region as the first core image, and set other portions of the adjusted image as the first peripheral image.

15. The image processing device of claim 10, wherein the image processor is configured to identify a target region in the initial image according to an adjustment signal; and
wherein the image processor is further configured to set a portion of the target region as the first core image, and set other portions of the target region as the first peripheral image according to the regional parameter.

16. The image processing device of claim 15, wherein the image processor is configured to non-linearly reduce the first peripheral image so that the first core image and the reduced first peripheral image form to a target image; and
wherein the image processor is further configured to linearly enlarge the target image to form the second core image and the second peripheral image.

17. The image processing device of claim 15, wherein the image processor is configured to center on a coordinate position indicated by the adjustment signal, and set the target region in the initial image according to a preset range.

18. The image processing device of claim 17, wherein the image processor is configured to maintain a display ratio of other regions in the initial image except the target region, as a background image; and
wherein the image processor is further configured to integrate the background image, the second core image and the second peripheral image into an output image, wherein the size of the output image is equal to the size of the initial image.

19. The image processing device of claim 17, wherein an total area of the second core image and the second peripheral image is equal to an area of the target region.

20. An image processor configured to receive an initial image, and configured for:
setting a first core image and a first peripheral image according to a regional parameter and the initial image, wherein the region parameter is configured to indicate the size of the first core image; and
adjusting the sizes of the first core image and the first peripheral image respectively to generate a second core image and a second peripheral image, wherein an adjustment ratio of the first core image and an adjustment ratio the first peripheral image are different.
